(19) United States
(12) Patent Application Publication
(10) Pub. No.: US 2024/0158611 A1
(43) Pub. Date: May 16, 2024

(54) COMPOSITION AND METHOD FOR INHIBITING THE FORMATION AND GROWITH OF POPCORN POLYMERS

(71) Applicant: BL Technologies, Inc., Minnetonka, MN (US)

(72) Inventors: Joop DEES, Minnetonka, MN (US); Jens MAGGEN, Minnetonka, MN (US); Chaowei FENG, Minnetonka, MN (US); Bryan CROM, Minnetonka, MN (US); David HOOD, Minnetonka, MN (US)

(21) Appl. No.: 18/548,013

(22) PCT Filed: Feb. 21, 2022
(86) PCT No.: PCT/US22/17159

§ 371 Date: Aug. 25, 2023

Related U.S. Application Data
(60) Provisional application No. 63/154,266, filed on Feb. 26, 2021.

(51) Int. Cl. C08K 5/07; C08F 112/08; C08K 5/13; C08K 5/17; C08K 5/18; C08K 5/3435

(52) U.S. Cl. CPC C08K 5/07; C08F 112/08; C08K 5/13; C08K 5/17; C08K 5/18; C08K 5/3435

(57) ABSTRACT

A method of minimizing popcorn polymer seed formation, the method adding a treatment composition to a monomer containing system. A method for inhibiting popcorn polymer growth, the method adding a treatment composition to a monomer containing system, wherein the treatment composition comprises a quinone methide, a quinone methide derivative, or a quinone methide analogue based compound, and wherein the system comprises popcorn seed or polymer.

### CROSS REFERENCE TO RELATED APPLICATION

This is a U.S. National Stage Entry of International Application No. PCT/US2022/017159, filed Feb. 21, 2022 which claims the benefit of priority to U.S. Provisional Patent Application Ser. No. 63/154,266 filed Feb. 26, 2021, which are incorporated by reference herein in their entirety.

### FIELD OF INVENTION

The disclosed technology provides for a treatment composition and method to inhibit the formation and growth of popcorn polymers, and more specifically, a treatment composition and method of minimizing popcorn polymer seed formation and inhibiting popcorn polymer growth.

### BACKGROUND OF THE INVENTION

In olefin production, a porous crosslinked polymer, described as “popcorn” or “popcorn polymer”, forms occasionally in the apparatus due to olefin polymerization in the step of refining and recovery. Popcorn polymer also occurs during monomer recovery steps in synthetic rubber production. Numerous monomers can experience the formation of popcorn polymers, including olefins such as styrene, vinyl acetate, acrylic acid, and esters and diolefins, such as isoprene, 1,3-butadiene, or chloroprene.

Popcorn is a unique form of polymer in terms of unique appearance/properties, formation mechanism, growth characteristics and process hazards. For example, the popcorn polymer fouls and adheres to the apparatus and pipelines in the refining and recovering systems, including distillation tower and heat exchanger. This often clogs the pipeline and apparatus, leading to the decrease of refining efficiency. In more serious cases, excessive growth of popcorn polymer can generate significant mechanical stress to deform or rupture the pipeline or apparatus, causing release of flammable olefin vapors which can lead to plant fire or explosions. Popcorn polymers can occur in either liquid phase or gaseous phase. Higher monomer concentration is more likely to form popcorn polymers.

Popcorn polymer formation basically consists of two stages. The first stage is popcorn seed formation through a series of transformation steps. The second stage involves rapid seed growth into large lumps of popcorn polymer in the presence of monomer in a self-accelerated propagation rate. The growth rate increases exponentially with time due to newly formed free radical actives sites or seeds, which are caused by fracture of popcorn polymer during growth.

Popcorn polymer is insoluble in any solvent and heat resistant due to its crosslinked nature. The current industrial practice to remove the popcorn polymer fouling includes temporal suspension and disassembly of the apparatus for cleaning mechanically. This reduces the run length and causes significant economic loss. Conventional inhibitors, such as alkyl phenols, stable free radicals, or hydroxylamines, have been used to minimize the popcorn polymer, primarily by limiting the formation of popcorn seeds. However, they need to be continuously supplied to the process during the operation and are ineffective in preventing popcorn seed growth once the seeds are formed.

Popcorn seeds can form under certain circumstances, such as temporal suspension or insufficient feeding of inhibitors, during turnaround (i.e. temporal suspension of the operation), or insufficient mechanical cleaning. The formed seeds then grow into large popcorn polymer lumps to foul or damage the apparatus even in presence of conventional inhibitors owing to their ineffective inhibition against the seeds. Therefore, inhibiting the popcorn seed propagation is also important.

Thus, what is needed in the art is a method to overcome the challenges of popcorn polymer by effectively preventing the seeds formation and/or growth.

### SUMMARY OF THE INVENTION

The disclosed technology provides for a treatment composition and method of minimizing popcorn polymer seed formation and inhibiting popcorn polymer growth.

In one aspect of the disclosed technology, a method of minimizing popcorn polymer seed formation is provided. The method comprising: adding a treatment composition to a monomer containing system, the system being capable of forming popcorn polymer seed or comprises popcorn polymer seeds.

In some embodiments, the monomer containing system comprises an olefin monomer production system, a monomer recovery process, or a monomer production process. In some embodiments, the system comprises styrene, vinyl acetate, acrylic acid, isoprene, 1,3-butadiene, or chloroprene.

In some embodiments, the treatment composition comprises a quinone methide based compound. In some embodiments, the quinone methide based compound comprises a quinone methide oligomer, a quinone methide polymer, or quinone methide derivative.

In some embodiments, the quinone methide based compound is a quinone methide derivative having the formula (I)

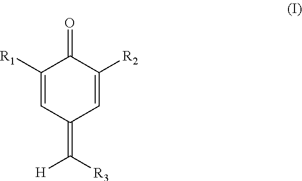

wherein R1 and R2 are independently H, C4 to C18 alkyl; C5 to C12 cycloaklyl; or C7 to C15 phenylalkyl; and R3 is aryl, or aryl substituted with C1 to C6 alkyl, alkoxy, hydroxy, nitro, amino, carboxy, or mixtures thereof.

In some embodiments, the quinone methide based compound comprises 4,4′-(Phenylmethylene)bis[2,6-bis(2-methyl-2-propanyl)phenol] or 4,4′-(Phenylmethoxy)bis[2,6-di-tert-butyl)phenol]. In some embodiments, the quinone methide based compound comprises 2,6-ditert-butyl-4-((3,5-di-tert-butyl-4-hydroxy-benzylidene)-cyclohexa-2,5-dienone, or 4-benzylidene-2,6-di-tert-butylcyclohexa-2,5-dienone. In some embodiments, the quinone methide derivative comprises 4,4′-Methylenebis(2,6-di-tert-butylphenol), 2,2′-Methylenebis(6-tert-butyl-4-ethylphenol), 2,2′-Methylenebis(4-methyl-6-tert-butylphenol), or 1,3,5-Trimethyl-2,4,6-tris(3,5-di-tert-butyl-4-hydroxybenzyl)benzene.

In some embodiments, the treatment composition further comprises an antioxidant, an anti-polymerant, a metal chelant, and/or an oxygen scavenger.

In some embodiments, the treatment composition comprises an antioxidant or an anti-polymerant, and wherein said antioxidant or anti-polymerant comprises amino phenols, amino cresols, phenylene diamine compounds, butylated hydroxytoluene, cresylic acid, butylated hydroxyanisole, p-cresol, p-methoxyphenol, dimethylphenols, propyl gallate, p-(p-methoxybenzylidene)amino)phenol, 2,2′-Ethylidenebis(4,6-di-tert-butylphenol), (2,2,6,6-Tetramethylpiperidin-1-yl)oxyl, dialkyl thiodipropinates, aryl and alkylphosphites, metal salts of dithioacids, hydroquinones, or combinations thereof.

In some embodiments, the metal chelant comprises alkyphenol-formaldehyde-amine adducts, N,N′-disalieylidene-1,2-propanediamine, 2,2′-methylidene-bis(2,6-di t-butyl-cresol), and combinations thereof.

In some embodiments, the oxygen scavenger comprises diethylhydroxylamine, hydroxypropyl hydroxylamine, catalyzed hydroxylamines, and combinations thereof. In some embodiments, the catalyzed hydroxylamines comprise a combination of hydroquinone with (i) diethylhydroxylamine, and/or (ii) hydroxypropyl hydroxylamine.

In yet another aspect of the disclosed technology, a method for inhibiting popcorn polymer growth is provided. The method comprising: adding a treatment composition to a monomer containing system, wherein the treatment composition comprises a quinone methide, a quinone methide derivative, or a quinone methide analogue based compound, and wherein the system comprises popcorn seed or polymer.

In some embodiments, the monomer containing system comprises an olefin monomer production system, a monomer recovery process, or a monomer production process. In some embodiments, the system comprises styrene, vinyl acetate, acrylic acid, isoprene, 1,3-butadiene, or chloroprene.

In some embodiments, the treatment composition comprises a quinone methide based compound, the quinone methide based compound comprising a quinone methide oligomer, a quinone methide polymer, or quinone methide derivative.

In some embodiments, the quinone methide based compound is a quinone methide derivative having the formula (I)

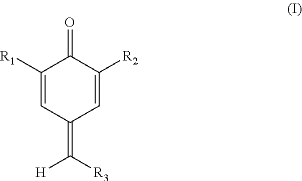

wherein R₁ and R₂ are independently H, C4 to C18 alkyl; C5 to C12 cycloaklyl; or C7 to C15 phenylalkyl; and R₃ is aryl, or aryl substituted with C1 to C6 alkyl, alkoxy, hydroxy, nitro, amino, carboxy, or mixtures thereof.

In some embodiments, the quinone methide based compound comprises 2,6-ditert-butyl-4-((3,5-di-tert-butyl-4-hydroxy-benzylidene)-cyclohexa-2,5-dienone, 4-benzylidene-2,6-di-tert-butylcyclohexa-2,5-dienone. In some embodiments, the quinone methide based compound comprises 4,4′-(Phenylmethylene)bis[2,6-bis(2-methyl-2-propanyl)phenol] or 4,4′-(Phenylmethoxy)bis[2,6-di-tert-butyl)phenol]. In some embodiments, the quinone methide derivative comprises 4,4′-Methylenebis(2,6-di-tert-butylphenol), 2,2′-Methylenebis(6-tert-butyl-4-ethylphenol), 2,2′-Methylenebis(4-methyl-6-tert-butylphenol), or 1,3,5-Trimethyl-2,4,6-tris(3,5-di-tert-butyl-4-hydroxybenzyl)benzene.

In some embodiments, the treatment composition further comprises an antioxidant, an anti-polymerant, a metal chelant, and/or an oxygen scavenger.

In some embodiments, treatment composition comprises an antioxidant or an anti-polymerant, wherein said antioxidant or anti-polymerant comprises amino phenols, amino cresols, phenylene diamine compounds, butylated hydroxytoluene, cresylic acid, butylated hydroxyanisole, p-cresol, p-methoxyphenol, dimethylphenols, propyl gallate, p-(p-methoxybenzylidene)amino)phenol, 2,2′-Ethylidenebis(4,6-di-tert-butylphenol), (2,2,6,6-Tetramethylpiperidin-1-yl)oxyl, dialkyl thiodipropinates, aryl and alkylphosphites, metal salts of dithioacids, hydroquinones, or combinations thereof.

In some embodiments, the treatment composition comprises a metal chelant, wherein said metal chelant comprises alkyphenol-formaldehyde-amine adducts, N,N′-disalieylidene-1,2-propanediamine, 2,2′-methylidene-bis(2,6-di t-butyl-cresol), or combinations thereof.

In some embodiments, the treatment composition comprises an oxygen scavenger, wherein said oxygen scavenger comprises diethylhydroxylamine, hydroxypropyl hydroxylamine, catalyzed hydroxylamines, or combinations thereof. In some embodiments, the catalyzed hydroxylamines comprise a combination of hydroquinone with (i) diethylhydroxylamine and/or (ii) hydroxypropyl hydroxylamine.

### BRIEF DESCRIPTION OF THE DRAWINGS

These and other features of the disclosed technology, and the advantages, are illustrated specifically in embodiments now to be described, by way of example, with reference to the accompanying diagrammatic drawings, in which:

FIG. 1 is a graph providing results of an illustrative embodiment of the disclosed technology; and

FIG. 2 is a graph providing results of an illustrative embodiment of the disclosed technology.

### DETAILED DESCRIPTION OF EXEMPLARY EMBODIMENTS

The disclosed technology provides for a treatment composition and method to inhibit the formation and growth of popcorn polymers, and more specifically, a treatment composition and method of minimizing popcorn polymer seed formation and inhibiting popcorn polymer growth. As used herein the terms “popcorn” and “popcorn polymer” are used interchangeably and refer to a specific type of porous crosslinked polymer which is proliferous, active, or pyrophoric in nature.

As previously explained, popcorn polymers can occur in either liquid phase or gaseous phase. Higher monomer concentration is more likely to form popcorn polymers, and where iron rust, oxygen (in presence of iron), or humidity are known initiators for popcorn polymerization. Popcorn polymer formation is basically consisted of two stages. The first stage is popcorn seed formation through a series of transformation steps. The second stage is rapid seed growth into large lumps of popcorn polymer in presence of monomer in a self-accelerated propagation rate, where the seeds will propagate until all monomer is consumed. The growth rate of popcorn polymer increases with time exponentially because new free radical actives sites or seeds are formed due to fracture of popcorn polymer caused by internal stress during growth. Also, termination rate is very low because the active free radicals are sterically immobilized. Because of this reason, the free radicals inside the popcorns have a long life.

In a first embodiment of the disclosed technology, a method of minimizing popcorn polymer seed formation is provided. The method comprises adding a treatment composition to a monomer containing system. The monomer containing system is capable of forming popcorn polymer seeds, or comprises popcorn polymer seeds. In such embodiments, the method prevents popcorn polymer formation by inhibiting or minimizing the formation of popcorn seeds.

In some embodiments, the treatment composition is added to an upstream portion of the monomer containing system, such as an ethylene production plant. In such embodiments, the treatment composition is added to all or a portion of a hydrocarbon stream entering/within the condensate stripper/gasoline stripper unit of an ethylene production unit. In some embodiments, the treatment composition is added to all or a portion of a hydrocarbon stream entering/within the charge gas compressor of an ethylene production unit. In some embodiments, the treatment composition is added to all or a portion of a hydrocarbon stream entering or within the ethylene fractionation/purification train (e.g. deethanizer, depropanizer, debutanizer towers and the interconnected series of exchangers, towers, reboilers, etc.).

The treatment composition comprises a quinone methide based compound. In some embodiments, the quinone methide (QM) based compound comprises a quinone methide oligomer, a quinone methide polymer, or quinone methide derivative. As described herein, quinone methide (QM) and its derivatives can prevent popcorn polymer formation by inhibiting the popcorn seeds formation or growth

In some embodiments, the quinone methide based compound is a quinone methide derivative having the formula (I)

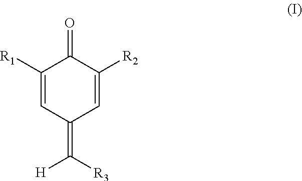

wherein R1 and R2 are independently H, C4 to C18 alkyl; C5 to C12 cycloaklyl; or C7 to C15 phenylalkyl; and R3 is aryl, or aryl substituted with C1 to C6 alkyl, alkoxy, hydroxy, nitro, amino, carboxy, or mixtures thereof.

In some embodiments, the quinone methide based compound comprises 4,4′-(Phenylmethylene)bis[2,6-bis(2-methyl-2-propanyl)phenol], and/or 4,4′-(Phenylmethoxy)bis[2,6-di-tert-butyl)phenol].

In some embodiments, the quinone methide based compound comprises 2,6-ditert-butyl-4-((3,5-di-tert-butyl-4-hydroxy-benzylidene)-cyclohexa-2,5-dienone, and/or 4-benzylidene-2,6-di-tert-butylcyclohexa-2,5-dienone.

In some embodiments, the quinone methide derivative comprises 4,4′-Methylenebis(2,6-di-tert-butylphenol), 2,2′-Methylenebis(6-tert-butyl-4-ethylphenol), 2,2′-Methylenebis(4-methyl-6-tert-butylphenol), and/or 1,3,5-Trimethyl-2,4,6-tris(3,5-di-tert-butyl-4-hydroxybenzyl)benzene.

In some embodiments, the treatment composition further comprises an antioxidant or an anti-polymerant. It is believed that the presence of the antioxidant or an anti-polymerant as described herein minimizes popcorn seed formation, as well as popcorn seed growth.

In such embodiments, the antioxidant or anti-polymerant comprises amino phenols, amino cresols, phenylene diamine compounds, butylated hydroxytoluene, cresylic acid, butylated hydroxyanisole, p-cresol, p-methoxyphenol, dimethylphenols, propyl gallate, p-(p-methoxybenzylidene)amino)phenol, 2,2′-Ethylidenebis(4,6-di-tert-butylphenol), (2,2,6,6-Tetramethylpiperidin-1-yl)oxyl, dialkyl thiodipropinates, aryl and alkylphosphites, metal salts of dithioacids, hydroquinones, and/or combinations thereof.

In some embodiments, the treatment composition further comprises a metal chelant. It is believed that the presence of a metal chelant is useful in minimizing popcorn seed formation. In such embodiments, the metal chelant comprises alkyphenol-formaldehyde-amine adducts, N,N′-disalieylidene-1,2-propanediamine, 2,2′-methylidene-bis(2,6-di t-butyl-cresol), and/or combinations thereof.

In some embodiments, the treatment composition further comprises an oxygen scavenger. It is believed that the presence of oxygen scavengers is useful in minimizing popcorn seed formation. In such embodiments, the oxygen scavenger comprises diethylhydroxylamine, hydroxypropyl hydroxylamine, catalyzed hydroxylamines, and/or combinations thereof. In some embodiments, the catalyzed hydroxylamines comprise a combination of hydroquinone with (i) diethylhydroxylamine, and/or (ii) hydroxypropyl hydroxylamine.

In some embodiments, the scavenger composition is added to a downstream portion of the monomer containing system. In some embodiments, the scavenger composition is added to all or a portion of a hydrocarbon stream entering or within the butadiene extractive distillation unit. In some embodiments, the scavenger composition is added to all or a portion of a hydrocarbon stream entering or within a styrene-butadiene rubber production process.

In yet another embodiment of the disclosed technology, a method for inhibiting popcorn polymer growth is provided. The method provides for adding a treatment composition to a monomer containing system that comprises popcorn seed or polymer which is capable of further growing into larger popcorn polymer. The monomer containing system comprises a quinone methide, a quinone methide derivative, or a quinone methide analogue based compound.

In some embodiments, the monomer containing system as described herein comprises an olefin monomer production system, a monomer recovery process, or a monomer production process. In some embodiments, the monomer containing system comprises styrene, vinyl acetate, acrylic acid, isoprene, 1,3-butadiene, and/or chloroprene.

In some embodiments, the quinone methide based compound comprises a quinone methide oligomer, a quinone methide polymer, or quinone methide derivative. It is believed that the disclosed quinone methide based compounds as described herein scavenge the free radicals existing in the popcorn seeds or polymers to deactivate active growth sites, thereby inhibiting popcorn propagations. In some embodiments, the method provides for about 0.1 ppm to about 10,000 ppm (1%) of quinone methide compound in monomer. In some embodiments, the method provides for about 0.1 ppm to about 100,000 ppm (10%) of quinone methide compound in monomer.

In some embodiments, the quinone methide based compound is a quinone methide derivative having the formula (I)

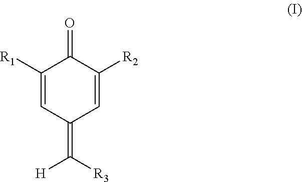

wherein R₁ and R₂ are independently H, C4 to C18 alkyl; C5 to C12 cycloaklyl; or C7 to C15 phenylalkyl; and R₃ is aryl, or aryl substituted with C1 to C6 alkyl, alkoxy, hydroxy, nitro, amino, carboxy, or mixtures thereof.

In some embodiments, the quinone methide based compound comprises 2,6-ditert-butyl-4-((3,5-di-tert-butyl-4-hydroxy-benzylidene)-cyclohexa-2,5-dienone, and/or 4-benzylidene-2,6-di-tert-butylcyclohexa-2,5-dienone.

In some embodiments, the quinone methide based compound comprises 4,4′-(Phenylmethylene)bis[2,6-bis(2-methyl-2-propanyl)phenol], and/or 4,4′-(Phenylmethoxy)bis[2,6-di-tert-butyl)phenol].

In some embodiments, the quinone methide derivative comprises 4,4′-Methylenebis(2,6-di-tert-butylphenol), 2,2′-Methylenebis(6-tert-butyl-4-ethylphenol), 2,2′-Methylenebis(4-methyl-6-tert-butylphenol), and/or 1,3,5-Trimethyl-2,4,6-tris(3,5-di-tert-butyl-4-hydroxybenzyl)benzene.

The treatment composition further comprises an antioxidant, an anti-polymerant, a metal chelant, and/or an oxygen scavenger.

In some embodiments, the antioxidant or anti-polymerant comprises amino phenols, amino cresols, phenylene diamine compounds, butylated hydroxytoluene, cresylic acid, butylated hydroxyanisole, p-cresol, p-methoxyphenol, dimethylphenols, propyl gallate, p-(p-methoxybenzylidene)amino)phenol, 2,2′-Ethylidenebis(4,6-di-tert-butylphenol), (2,2,6,6-Tetramethylpiperidin-1-yl)oxyl, dialkyl thiodipropinates, aryl and alkylphosphites, metal salts of dithioacids, hydroquinones, and/or combinations thereof.

In some embodiments, the metal chelant comprises alkyphenol-formaldehyde-amine adducts, N,N′-disalieylidene-1,2-propanediamine, 2,2′-methylidene-bis(2,6-di t-butyl-cresol), and/or combinations thereof.

In some embodiments, the oxygen scavenger comprises diethylhydroxylamine, hydroxypropyl hydroxyl amine, catalyzed hydroxyl amines, and/or combinations thereof. In some embodiments, the catalyzed hydroxylamines comprise a combination of hydroquinone with (i) diethylhydroxylamine and/or (ii) hydroxypropyl hydroxylamine.

### EXAMPLES

The present technology will be further described in the following examples, which should be viewed as being illustrative and should not be construed to narrow the scope of the disclosed technology or limit the scope to any particular embodiments.

Approximately 0.2 g of popcorn seeds received from a chemical plant were added to 10 ml of styrene monomer (inhibitor removed) which was then dosed with 100 ppm inhibitor treatment. The solution was purged using argon for 5 minutes to remove dissolved oxygen, and then placed in an oven at 60° C. to initiate seed growth. Popcorn polymer height was measured and recorded as a function of time. After 45 hours, the popcorn was purified, dried, and then weighed to determine the final polymer amount. Growth rate was calculated according to ln(W_{f}/W₀) in which W_{f} is the final popcorn polymer weight and W₀ is the initial seed weight.

Each test was repeated two times and the average growth rate was calculated. Blank test without any inhibitor treatment was included as control. Different chemical compounds including N,N′-Di-sec-butyl-p-phenylenediamine (PDA), 2,6-Di-tert-butyl-4-methylphenol (BHT), N,N-Diethylhydroxylamine (DEHA), Hydroquinone (HQ), 4-Hydroxy-TEMPO (4-OH), and 2,5-Cyclohexadien-1-one,2,6-bis(1,1-dimethylethyl)-4-(phenylmethylene)-(QM) were tested for comparison. The results are summarized in Table 1 below.

TABLE 1

| | | | | | | | Popcorn | Growth | Ave. Growth | Growth |
|---|---|---|---|---|---|---|---|---|---|---|
| | | Popcorn height (mm) | | | | | weight | rate | rate | rate/hour |
| | | | 4 | 20 | 26 | 45 | (final) | (45 | (45 | (Rate |
| Vial | Treatment | Start | hours | hours | hours | hours | (g) | hours) | hours) | constant k) |
| 1 | Blank | 18 | 18 | 44 | 45 | 45 | 7.1262 | 3.54 | 3.41 | 0.0758 |
| 2 | Blank | 10 | 10 | 42 | 44 | 45 | 5.3116 | 3.27 | | |
| 3 | PDA | 13 | 13 | 40 | 43 | 45 | 5.5933 | 3.30 | 3.37 | 0.0749 |
| 4 | PDA | 10 | 10 | 40 | 43 | 45 | 6.4306 | 3.44 | | |
| 5 | BHT | 12 | 12 | 45 | 45 | 45 | 7.5058 | 3.62 | 3.56 | 0.0791 |
| 6 | BHT | 12 | 12 | 45 | 45 | 45 | 6.6708 | 3.49 | | |
| 7 | DEHA | 11 | 11 | 13 | 14 | 42 | 2.438 | 2.50 | 2.63 | 0.0584 |
| 8 | DEHA | 15 | 15 | 17 | 18 | 43 | 3.1884 | 2.75 | | |
| 9 | HQ | 12 | 12 | 15 | 16 | 35 | 3.0583 | 2.72 | 2.76 | 0.0613 |
| 10 | HQ | 15 | 15 | 20 | 21 | 38 | 3.2626 | 2.80 | | |
| 11 | 4-OH | 12 | 12 | 13 | 13 | 41 | 1.4761 | 1.97 | 1.97 | 0.0438 |
| 12 | 4-OH | 12 | 12 | 13 | 13 | 40 | 1.4929 | 1.97 | | |
| 13 | QM | 13 | 13 | 15 | 15 | 37 | 0.4393 | 0.79 | 0.56 | 0.0124 |
| 14 | QM | 12 | 12 | 15 | 15 | 30 | 0.2778 | 0.32 | | |

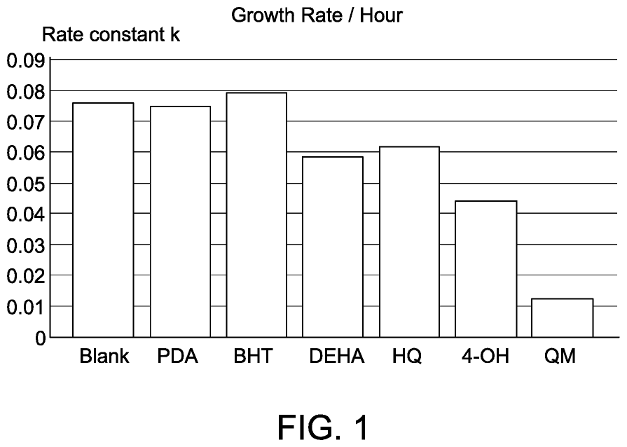

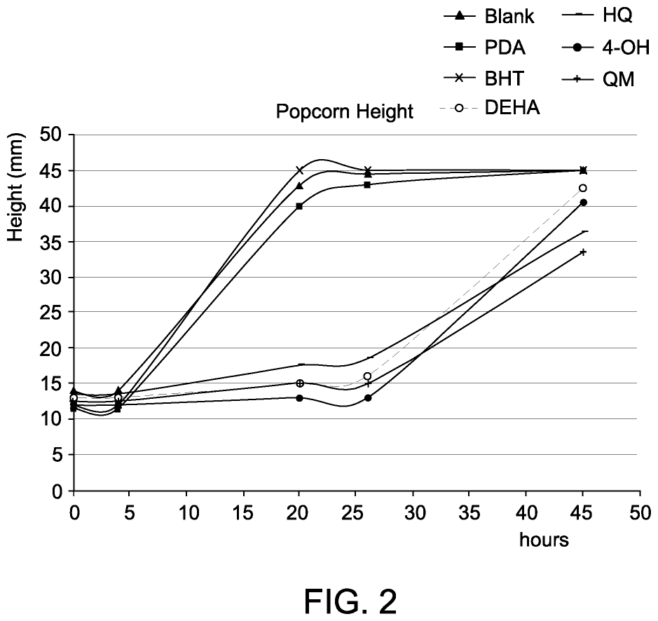

The growth rate for each chemical compound is compared in FIG. 1. Popcorn height is plotted as function of time in FIG. 2. These results indicate that quinone methide exhibited the best inhibition performance among all the tested compounds. Quinone methide (QM) was very effective in inhibiting popcorn seed propagation, thereby preventing popcorn polymer formation.

While embodiments of the disclosed technology have been described, it should be understood that the present disclosure is not so limited and modifications may be made without departing from the disclosed technology. The scope of the disclosed technology is defined by the appended claims, and all devices, processes, and methods that come within the meaning of the claims, either literally or by equivalence, are intended to be embraced therein.

1. A method of minimizing popcorn polymer seed formation, the method comprising:
adding a treatment composition to a monomer containing system, said system being capable of forming popcorn polymer seed or comprises popcorn polymer seeds.

2. The method according to claim 1, wherein said monomer containing system comprises an olefin monomer production system, a monomer recovery process, or a monomer production process.

3. The method according to claim 1, wherein said system comprises styrene, vinyl acetate, acrylic acid, isoprene, 1,3-butadiene, or chloroprene.

4. The method according to claim 1, wherein said treatment composition comprises a quinone methide based compound.

5. The method according to claim 4, wherein said quinone methide based compound comprises a quinone methide oligomer, a quinone methide polymer, or quinone methide derivative.

6. The method according to claim 5, wherein said quinone methide based compound is a quinone methide derivative having the formula (I) 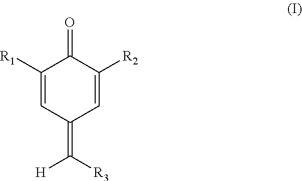
wherein R1 and R2 are independently H, C4 to C18 alkyl; C5 to C12 cycloaklyl; or C7 to C15 phenylalkyl; and R3 is aryl, or aryl substituted with C1 to C6 alkyl, alkoxy, hydroxy, nitro, amino, carboxy, or mixtures thereof.

7. The method according to claim 5, wherein said quinone methide based compound comprises 4,4′-(Phenylmethylene)bis[2,6-bis(2-methyl-2-propanyl)phenol] or 4,4′-(Phenylmethoxy)bis[2,6-di-tert-butyl)phenol].

8. The method according to claim 5, wherein said quinone methide based compound comprises 2,6-ditert-butyl-4-((3,5-di-tert-butyl-4-hydroxy-benzylidene)-cyclohexa-2,5-dienone, or 4-benzylidene-2,6-di-tert-butylcyclohexa-2,5-dienone.

9. The method according to claim 5, wherein said quinone methide derivative comprises 4,4′-Methylenebis(2,6-di-tert-butylphenol), 2,2′-Methylenebis(6-tert-butyl-4-ethylphenol), 2,2′-Methylenebis(4-methyl-6-tert-butylphenol), or 1,3,5-Trimethyl-2,4,6-tris(3,5-di-tert-butyl-4-hydroxybenzyl)benzene.

10. The method according to claim 4, wherein said treatment composition further comprises an antioxidant, an anti-polymerant, a metal chelant, and/or an oxygen scavenger.

11. The method according to claim 10, wherein said treatment composition comprises an antioxidant or an anti-polymerant, and wherein said antioxidant or anti-polymerant comprises amino phenols, amino cresols, phenylene diamine compounds, butylated hydroxytoluene, cresylic acid, butylated hydroxyanisole, p-cresol, p-methoxyphenol, dimethylphenols, propyl gallate, p-(p-methoxybenzylidene)amino)phenol, 2,2′-Ethylidenebis(4,6-di-tert-butylphenol), (2,2,6,6-Tetramethylpiperidin-1-yl)oxyl, dialkyl thiodipropinates, aryl and alkylphosphites, metal salts of dithioacids, hydroquinones, or combinations thereof.

12. The method according to claim 10, wherein said metal chelant comprises alkyphenol-formaldehyde-amine adducts, N,N′-disalieylidene-1,2-propanediamine, 2,2′-methylidene-bis(2,6-di t-butyl-cresol), and combinations thereof.

13. The method according to claim 10, wherein said oxygen scavenger comprises diethylhydroxylamine, hydroxypropyl hydroxylamine, catalyzed hydroxylamines, and combinations thereof.

14. The method according to claim 13, wherein said catalyzed hydroxylamines comprise a combination of hydroquinone with (i) diethylhydroxylamine and/or (ii) hydroxypropyl hydroxylamine.

15. A method for inhibiting popcorn polymer growth, the method comprising:
adding a treatment composition to a monomer containing system, wherein said treatment composition comprises a quinone methide, a quinone methide derivative, or a quinone methide analogue based compound, and wherein said system comprises popcorn seed or polymer.

16. The method according to claim 15, wherein said monomer containing system comprises an olefin monomer production system, a monomer recovery process, or a monomer production process.

17. The method according to claim 15, wherein said system comprises styrene, vinyl acetate, acrylic acid, isoprene, 1,3-butadiene, or chloroprene.

18. The method according to claim 15, wherein said treatment composition comprises a quinone methide based compound, said quinone methide based compound comprising a quinone methide oligomer, a quinone methide polymer, or quinone methide derivative.

19. The method according to claim 18, wherein said quinone methide based compound is a quinone methide derivative having the formula (I) 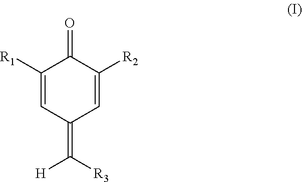
wherein R₁ and R₂ are independently H, C4 to C18 alkyl; C5 to C12 cycloaklyl; or C7 to C15 phenylalkyl; and R₃ is aryl, or aryl substituted with C1 to C6 alkyl, alkoxy, hydroxy, nitro, amino, carboxy, or mixtures thereof.

20. The method according to claim 18, wherein said quinone methide based compound comprises 2,6-ditert-butyl-4-((3,5-di-tert-butyl-4-hydroxy-benzylidene)-cyclohexa-2,5-dienone, 4-benzylidene-2,6-di-tert-butylcyclohexa-2,5-dienone.

21. The method according to claim 18, wherein said quinone methide based compound comprises 4,4′-(Phenylmethylene)bis[2,6-bis(2-methyl-2-propanyl)phenol] or 4,4′-(Phenylmethoxy)bis[2,6-di-tert-butyl)phenol].

22. The method according to claim 18, wherein said quinone methide derivative comprises 4,4′-Methylenebis(2,6-di-tert-butylphenol), 2,2′-Methylenebis(6-tert-butyl-4-ethylphenol), 2,2′-Methylenebis(4-methyl-6-tert-butylphenol), or 1,3,5-Trimethyl-2,4,6-tris(3,5-di-tert-butyl-4-hydroxybenzyl)benzene.

23. The method according to claim 15, wherein said treatment composition further comprises an antioxidant, an anti-polymerant, a metal chelant, and/or an oxygen scavenger.

24. The method according to claim 23, wherein said treatment composition comprises an antioxidant or an anti-polymerant, wherein said antioxidant or anti-polymerant comprises amino phenols, amino cresols, phenylene diamine compounds, butylated hydroxytoluene, cresylic acid, butylated hydroxyanisole, p-cresol, p-methoxyphenol, dimethylphenol s, propyl gallate, p-(p-methoxybenzylidene)amino)phenol, 2,2′-Ethylidenebis(4,6-di-tert-butylphenol), (2,2,6,6-Tetramethylpiperidin-1-yl)oxyl, dialkyl thiodipropinates, aryl and alkylphosphites, metal salts of dithioacids, hydroquinones, or combinations thereof.

25. The method according to claim 23, wherein said treatment composition comprises a metal chelant, wherein said metal chelant comprises alkyphenol-formaldehyde-amine adducts, N,N′-disalieylidene-1,2-propanediamine, 2,2′-methylidene-bis(2,6-di t-butyl-cresol), or combinations thereof.

26. The method according to claim 23, wherein said treatment composition comprises an oxygen scavenger, wherein said oxygen scavenger comprises diethylhydroxylamine, hydroxypropyl hydroxylamine, catalyzed hydroxylamines, or combinations thereof.

27. The method according to claim 26, wherein said catalyzed hydroxylamines comprise a combination of hydroquinone with (i) diethylhydroxylamine and/or (ii) hydroxypropyl hydroxylamine.
